(19) United States
(12) Patent Application Publication
(10) Pub. No.: US 2025/0157718 A1
(43) Pub. Date: May 15, 2025

(54) COIL COMPONENT

(71) Applicant: Murata Manufacturing Co., Ltd., Kyoto-fu (JP)

(72) Inventors: Akio IGARASHI, Nagaokakyo-shi (JP); Katsuyuki TAKAHASHI, Nagaokakyo-shi (JP)

(73) Assignee: Murata Manufacturing Co., Ltd., Kyoto-fu (JP)

(21) Appl. No.: 18/883,011

(22) Filed: Sep. 12, 2024

(30) Foreign Application Priority Data
Nov. 14, 2023 (JP) 2023-193700

(51) Int. Cl. H01F 27/26; H01F 27/28; H01F 27/29

(52) U.S. Cl. CPC H01F 27/263; H01F 27/2828; H01F 27/292

(57) ABSTRACT

A coil component includes a drum core that is a first core, a plate core that is a second core, and a wire. The drum core includes the columnar winding core portion, the first flange portion connected to the first end of the winding core portion in the direction parallel to the central axis line of the winding core portion, and the second flange portion connected to the second end of the winding core portion opposite to the first end. The plate core has a plate shape having a first main surface. The first main surface is connected to the first flange portion and the second flange portion. The plate core has, on a side opposite to the first main surface, a second main surface parallel to the first main surface and an inclined plane inclined with respect to the second main surface.

### CROSS-REFERENCE TO RELATED APPLICATION

This application claims benefit of priority to Japanese Patent Application No. 2023-193700, filed Nov. 14, 2023, the entire content of which is incorporated herein by reference.

### BACKGROUND

### Technical Field

The present disclosure relates to a coil component.

### Background Art

A coil component described in Japanese Patent No. 6672614 includes a drum core, two outer electrodes, a wire, and a plate core. The drum core includes a winding core portion, a first flange portion, and a second flange portion. The winding core portion has a quadrangular prism shape. The first flange portion is connected to a first end of the winding core portion. The second flange portion is connected to a second end of the winding core portion. One outer electrode is attached to each of the flange portions. The wire is wound around the winding core portion. A first end of the wire is connected to the outer electrode closer to the first flange portion. A second end of the wire is connected to the outer electrode closer to the second flange portion.

The plate core is connected to an end surface of the surfaces of the first flange portion that is opposite to a surface on which the outer electrode is located. In addition, the plate core is connected to an end surface of the surfaces of the second flange portion that is opposite to a surface on which the outer electrode is located. That is, the plate core is bridged over the first flange portion and the second flange portion.

The plate core has two recessed portions on the outer surface opposite to the surface connected to the first flange portion and the second flange portion. The recessed portions are recessed from the outer surface. The recessed portions are truncated cone-shaped recesses.

### SUMMARY

In the coil component described in Japanese Patent No. 6672614, the posture of the coil component can be determined by observing recessed portions of a plate core. For example, an image of the plate core is taken at a position facing an outer surface of the plate core. Then, the posture of the coil component can be determined in accordance with the positional relationship between the two recessed portions in the taken image. However, this method assumes that the recessed portions on the surface of the plate core can be clearly distinguished from the outer surface having no recessed portions in the taken image. Accordingly, a high-definition imaging device may be required to take an image of the outer surface of the plate core.

Accordingly, the present disclosure provides a coil component including a first core including a columnar winding core portion, a first flange portion connected to a first end of the winding core portion in a direction parallel to a central axis line of the winding core portion, and a second flange portion connected to a second end of the winding core portion opposite to the first end; a plate-shaped second core having a first main surface; and a wire wound around the winding core portion. The first main surface is connected to the first flange portion, and the second flange portion, and the second core has, on a side opposite to the first main surface, a second main surface parallel to the first main surface and an inclined plane inclined with respect to the second main surface.

According to the structure described above, the posture of the coil component can be determined more easily.

### BRIEF DESCRIPTION OF THE DRAWINGS

FIG. 1 is a perspective view of a coil component;

FIG. 2 is a side view of the coil component;

FIG. 3 is a top view of the coil component;

FIG. 4 is an explanatory diagram for describing reflection of light when an image is taken while irradiating a plate core of the coil component with light;

FIG. 5 is a diagram illustrating a coil component according to a modification; and

FIG. 6 is a diagram illustrating the coil component according to a modification.

### DETAILED DESCRIPTION

A coil component according to an embodiment will be described below with reference to the drawings. It should be noted that, in some cases, components may be enlarged in the drawings for ease of understanding. The dimensional ratios of components may differ from those of actual components or may differ from each other between drawings.

### Overall Structure

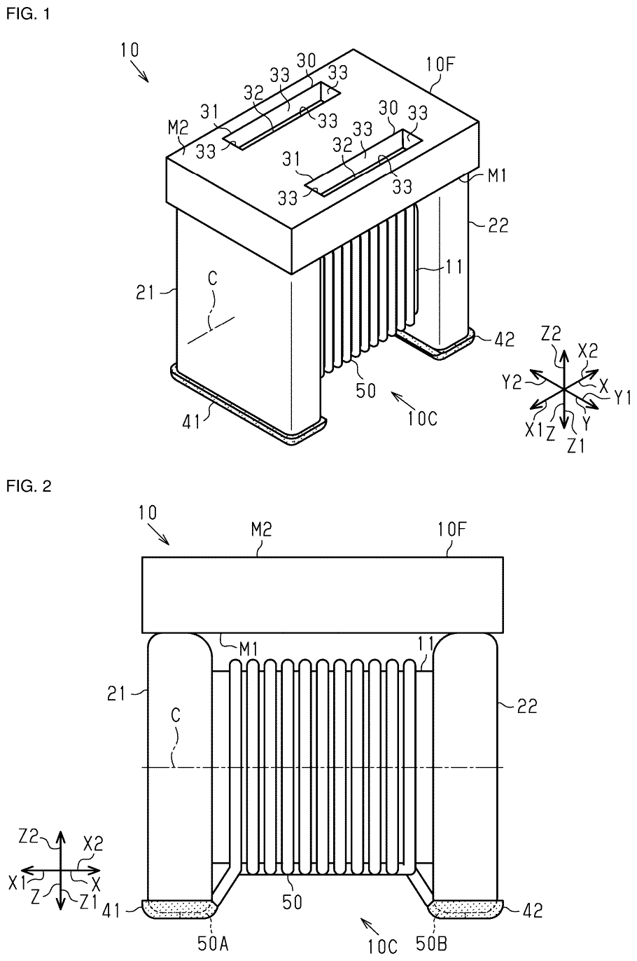

As illustrated in FIG. 1, the coil component 10 includes a drum core 10C as a first core and a plate core 10F as a second core.

The drum core 10C includes a columnar winding core portion 11, a first flange portion 21, and a second flange portion 22. The winding core portion 11 has a quadrangular prism shape. Accordingly, the winding core portion 11 extends along a central axis line C. The shape of the winding core portion 11 in cross-sectional view orthogonal to the central axis line C is a rectangle. It should be noted that “rectangle” refers to a shape that has four sides and is substantially rectangular and includes a shape with chamfered corners. The winding core portion 11 is made of a magnetic material. Specifically, the winding core portion 11 may be made of a mixture including, for example, Ni—Zn ferrite or Ni—Zn ferrite.

Here, a specific axis parallel to the central axis line C of the winding core portion 11 is referred to as a first axis X. The axis orthogonal to the first axis X is referred to as a second axis Y. In the embodiment, the second axis Y is parallel to two of the four sides of the winding core portion 11 as viewed in a direction parallel to the first axis X. In addition, the axis orthogonal to both the first axis X and the second axis Y is referred to as a third axis Z. In the embodiment, the third axis Z is parallel to the remaining two of the four sides of the winding core portion 11 as viewed in the direction parallel to the first axis X. In addition, one of the directions parallel to the first axis X is referred to as a first positive direction X1, and the direction opposite to the first positive direction X1 is referred to as a first negative direction X2. Similarly, one of the directions parallel to the second axis Y is referred to as a second positive direction Y1, and the direction opposite to the second positive direction Y1 is referred to as a second negative direction Y2. In addition, one of the directions parallel to the third axis Z is referred to as a third positive direction Z1, and the direction opposite to the third positive direction Z1 is referred to as a third negative direction Z2.

As illustrated in FIG. 1, the first flange portion 21 is connected to the first end of the winding core portion 11 in a direction parallel to the central axis line C. Specifically, the first flange portion 21 is connected to the first end of the winding core portion 11 in the first positive direction X1. The first flange portion 21 is formed integrally with the winding core portion 11. Accordingly, the first flange portion 21 is made of a magnetic material as the winding core portion 11. The first flange portion 21 projects outward in the direction of the second axis Y and in the direction of the third axis Z from the outer peripheral surface of the winding core portion 11.

The second flange portion 22 is connected to the second end opposite to the first end of the winding core portion 11. That is, the second flange portion 22 is connected to the second end that is an end of the winding core portion 11 in the first negative direction X2. The second flange portion 22 is formed integrally with the winding core portion 11. Accordingly, the second flange portion 22 is made of the same magnetic material as the winding core portion 11.

The plate core 10F has a rectangular plate shape. The dimension of the plate core 10F in the direction parallel to the first axis X is slightly larger than the dimension of the drum core 10C in the direction parallel to the first axis X. In addition, the dimension of the plate core 10F in the direction parallel to the secondary axis Y is slightly larger than the dimension of the drum core 10C in the direction parallel to the secondary axis Y. The dimension of the plate core 10F in the direction parallel to the third axis Z is smaller than the dimension of the plate core 10F in the direction parallel to the first axis X and the dimension of the plate core 10F in the secondary axis Y. The long sides of the plate core 10F are parallel to the first axis X. The short sides of the plate core 10F are parallel to the secondary axis Y.

The plate core 10F is located in the third negative direction Z2 with respect to the drum core 10C. The plate core 10F is connected to both a surface of the first flange portion 21 that faces the third negative direction Z2 and a surface of the second flange portion 22 that faces the third negative direction Z2. That is, the plate core 10F is bridged over the first flange portion 21 and the second flange portion 22. In plan view in the direction parallel to the third axis Z, a virtual line that divides the plate core 10F in the direction parallel to the secondary axis Y is aligned with the central axis line C of the winding core portion 11. The plate core 10F is made of the same magnetic material as the drum core 10C.

The coil component 10 includes a first outer electrode 41 and a second outer electrode 42. The first outer electrode 41 covers the entire surface facing the third positive direction Z1 of the surfaces of the first flange portion 21. Although not illustrated in the drawing, the first outer electrode 41 has a metal layer and a plating layer. The metal layer is made of silver. The metal layer is laminated on the surface of the first flange portion 21. The plating layer includes three layers laminated on the surface of the metal layer. Copper, nickel, and tin layers are laminated in this order from a side closer to the metal layer on the plating layer.

The second outer electrode 42 covers the entire surface of the second flange portion 22 that faces the third positive direction Z1. The structure of the second outer electrode 42 is the same as that of the first outer electrode 41. That is, the second outer electrode 42 includes the metal layer and a plating layer having a three-layer structure.

It should be noted that the end surfaces of the coil component 10 in the third positive direction Z1 on which the first outer electrode 41 and the second outer electrode 42 are located are the mounting surfaces that face the substrate when the coil component 10 is mounted on the substrate.

As illustrated in FIG. 1, the coil component 10 includes a wire 50 wound around the winding core portion 11. Although not illustrated in the drawing, the wire 50 includes a copper wire and an insulating coating. The insulating coating covers the outer surface of the copper wire. The shape of the wire 50 is substantially a circle in cross-sectional view orthogonal to the direction in which the wire 50 extends.

As illustrated in FIG. 2, a first wire end 50A of the wire 50 is connected to the first outer electrode 41. A second wire end 50B of the wire 50 is connected to the second outer electrode 42. The wire 50 is wound around the winding core portion 11 so as to rotate counterclockwise from the first wire end 50A to the second wire end 50B as viewed in the first negative direction X2.

### Recessed Portion of Plate Core

As illustrated in FIG. 2, the plate core 10F has a plate shape with a first main surface M1. The first main surface M1 is connected to the first flange portion 21 and the second flange portion 22. In addition, the plate core 10F has a second main surface M2 parallel to the first main surface M1 on a side opposite to the first main surface M1. It should be noted that “parallel” allows slight a deviation caused by manufacturing error and the like. The shape of the first main surface M1 and the second main surface M2 is a rectangle having a longitudinal direction parallel to the first axis X direction. In addition, both the first main surface M1 and the second main surface M2 are orthogonal to the third axis Z.

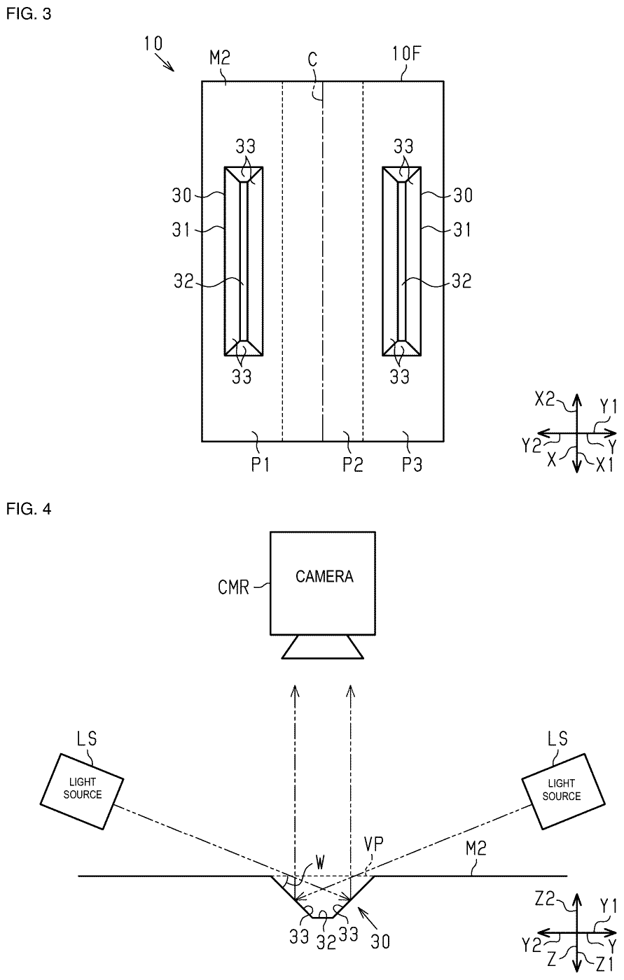

As illustrated in FIG. 1, the plate core 10F has two recessed portions 30 that are recessed in the second main surface M2. Since the two recessed portions 30 have the same shape, the shape of one of the recessed portions 30 will be described. The recessed portion 30 has a truncated quadrangular pyramid shape. Accordingly, as illustrated in FIG. 3, the shape of the opening edge 31 of the recessed portion 30 is a rectangle as viewed in a direction orthogonal to the second main surface M2. In the embodiment, the shape of the opening edge 31 of the recessed portion 30 is a rectangle with a longitudinal direction parallel to the first axis X. That is, two long sides of the opening edge 31 of the recessed portion 30 are parallel to the first axis X. Two short sides of the opening edge 31 of the recessed portion 30 are parallel to the secondary axis Y.

The recessed portion 30 has a bottom surface 32 and four inclined planes 33. That is, the plate core 10F has the inclined planes 33. The shape of the bottom surface 32 is similar to the shape of the opening edge 31 of the recessed portion 30 and is smaller than the opening edge 31. That is, as viewed in the direction orthogonal to the second main surface M2, the shape of the bottom surface 32 is a rectangle having a longitudinal direction parallel to the first axis X.

The inclined planes 33 extend from the second main surface M2 toward the bottom surface 32 of the recessed portion 30. That is, the inclined plane 33 extends from each of the four sides of the rectangular opening edge 31 toward the bottom of the recessed portion 30. Accordingly, the plate core 10F has four inclined planes 33 for each of the recessed portions 30. In addition, the edges of the inclined planes 33 closer to the bottom of the recessed portion 30 are connected to the sides of the outer edge of the bottom surface 32.

Here, “plane” means a flat surface when the entire plate core 10F is observed as a whole while slight irregularities that can be observed only by a microscope are ignored. Accordingly, the inclined planes 33 do not include curved surfaces that can be visually recognized when the plate core 10F is observed as a whole.

The inclined planes 33 are side surfaces of the recessed portion 30 having a truncated quadrangular pyramid shape. Accordingly, the inclined planes 33 are inclined with respect to the second main surface M2. In addition, the inclined plane 33 is inclined so as to closer to the facing inclined plane 33 as the inclined plane 33 approaches the bottom of the recessed portion 30. Here, as illustrated in FIG. 4, a virtual plane VP including the second main surface M2 is assumed. At this time, the angle W inside the recessed portion 30 formed by the virtual plane VP and the inclined plane 33 is not less than 10 degrees and not more than 80 degrees (i.e., from 10 degrees to 80 degrees), more preferably, not less than 35 degrees and not more than 55 degrees (i.e., from 35 degrees to 55 degrees). Specifically, in the embodiment, the angle W described above is approximately 45 degrees.

As illustrated in FIG. 3, as viewed in the direction orthogonal to the second main surface M2, the recessed portions 30 are not located on the central axis line C of the winding core portion 11. It should be noted that not being located on the central axis line C means that the central axis line C and the opening edges 31 of the recessed portions 30 do not intersect each other.

As illustrated in FIG. 3, it is assumed that the second main surface M2 is divided into three equal regions in a direction parallel to the second main surface M2 and orthogonal to the central axis line C of the winding core portion 11. The regions are designated as a first region P1, a second region P2, and a third region P3 in order from the second negative direction Y2 to the second positive direction Y1. At this time, one of the recessed portions 30 is located within the first region P1. Additionally, the remaining recessed portion 30 is located within the third region P3. That is, each of the recessed portions 30 is located within one of two regions excluding the second region P2 in the middle of the three regions.

Furthermore, the positional relationship between the two recessed portions 30 is line-symmetric about the central axis line C of the winding core portion 11 as viewed in the direction orthogonal to the second main surface M2. In other words, the two recessed portions 30 are in a mirror relationship about the central axis line C.

### Method of Determining Coil Component in the Embodiment

As illustrated in FIG. 4, it is assumed that light is emitted to the second main surface M2 from two light sources LS. One of the light sources LS is located in the second positive direction Y1 and in the third negative direction Z2 with respect to the second main surface M2. The other of the light sources LS is located in the second negative direction Y2 and in the third negative direction Z2 with respect to the second main surface M2. The light sources LS emit light to the second main surface M2 at angles inclined with respect to the second main surface M2.

For example, as illustrated in FIG. 4, it is assumed that light emitted from the light source LS located in the second positive direction Y1 and in the third negative direction Z2 with respect to the second main surface M2 is incident on the inclined plane 33 of the recessed portion 30 located in the second negative direction Y2. In this case, the light reflected on the inclined plane 33 travels approximately in the third negative direction Z2. On the other hand, when the light emitted from the light source LS is incident on the second main surface M2, the light is reflected on the second main surface M2 at an angle inclined with respect to the third negative direction Z2.

Similarly, it is assumed that light emitted from the light source LS located in the second negative direction Y2 and in the third negative direction Z2 with respect to the second main surface M2 is incident on the inclined plane 33 of the recessed portion 30 located in the second positive direction Y1. In this case, the light reflected on the inclined plane 33 travels approximately in the third negative direction Z2. On the other hand, when the light emitted from the light source LS is incident on the second main surface M2, the light is reflected on the second main surface M2 at an angle inclined with respect to the third negative direction Z2.

It is assumed that an image of the second main surface M2 is taken by a camera CMR from a side in the third negative direction Z2 under these conditions. In this case, an image of the two inclined planes 33 located in the second positive direction Y1 and in the second negative direction Y2 can be taken as regions with stronger reflected light than the second main surface M2.

### Effects of the Embodiment

(1) When light is emitted to the coil component 10 from the light source LS, the light is not necessarily emitted from directly above the coil component 10, and, in some cases, light need be emitted at an angle that is somewhat inclined with respect to the second main surface M2 of the plate core 10F. In the embodiment described above, the plate core 10F has the inclined planes 33 that are inclined with respect to the second main surface M2. When light is emitted to the second main surface M2 with the light inclined with respect to the second main surface M2 as described above, an image of any of the inclined planes 33 can be taken as a region with stronger reflected light than the second main surface M2. That is, the contrast between any one of the inclined planes 33 and the second main surface M2 becomes stronger in the taken image. For example, when an image taken as described above is binarized, image processing that makes only two of the inclined planes 33 bright and the other portions dark is easily performed. Accordingly, the posture of the coil component 10 can be determined in accordance with the inclined planes 33 without using a high-precision imaging device.
(2) In the embodiment described above, the inclined planes 33 are side surfaces of the recessed portion 30. If the inclined plane 33 projects from the second main surface M2 in the third negative direction Z2, the height dimension when mounting the coil component 10 is mounted on the substrate increases by the dimension of the inclined plane 33. In the structure described above, the height dimension of the coil component 10 can be suppressed as compared with the case in which the inclined plane 33 projects from the second main surface M2.
(3) In the embodiment described above, the inclined plane 33 extends from each of the four sides of the rectangular opening edge 31 of the recessed portion 30. In this structure, regardless of the direction in which light is emitted to the coil component 10, any of the four inclined planes 33 of the recessed portion 30 can be observed as a region with strong reflected light.
(4) It is assumed that the angle inside the recessed portion 30 formed by the virtual plane VP and the inclined plane 33 is close to 0 degrees or close to 90 degrees. In this case, to enhance the contrast between the inclined plane 33 and the second main surface M2 in the taken image, the angle of incidence of light on the second main surface M2 need be extremely large or extremely small. In the embodiment described above, the angle W is not less than 10 degrees and not more than 80 degrees (i.e., from 10 degrees to 80 degrees). When the angle W falls within this numerical range, even if the angle of incidence of light on the second main surface M2 is not an extreme angle, a difference in contrast between the inclined plane 33 and the second main surface M2 can be obtained in the taken image. That is, there is less restriction on the position of the light source LS.
(5) If current is applied to the coil component 10, a magnetic flux is concentrated on the central axis line C of the winding core portion 11 as viewed in the direction orthogonal to the second main surface M2 in the plate core 10F. In the embodiment described above, as viewed in the direction orthogonal to the second main surface M2, the recessed portion 30 is not located on the central axis line C of the winding core portion 11. Accordingly, in the structure described above, the volume of the plate core 10F can be suppressed from being reduced in a portion in which a magnetic flux is concentrated. That is, in the structure described above, the inductance of the coil component 10 can be suppressed from being reduced.
(6) In the embodiment described above, the recessed portion 30 is located in one of the two regions excluding the second region P2 in the middle of the three regions. That is, the recessed portion 30 is located to avoid a region including the central axis line C as viewed in the direction orthogonal to the second main surface M2. Accordingly, the structure described above is more preferred to suppress the inductance of the coil component 10 from being reduced.
(7) When the inclined plane 33 of the recessed portion 30 is not inclined at a designed angle with respect to the second main surface M2 due to, for example, manufacturing error or the like, contrast between the second main surface M2 and the inclined plane 33 is less likely to occur in the taken image. In the embodiment described above, the plate core 10F includes the two recessed portions 30. Since the plurality of recessed portions 30 are present as described above, even when the inclined planes 33 in one recessed portion 30 do not have contrast in the image, the inclined planes 33 of the other recessed portion 30 can be identified in the image.
(8) In the embodiment, the positional relationship between the two recessed portions 30 is line-symmetric about the central axis line C of the winding core portion 11 as viewed in the direction orthogonal to the second main surface M2. In this structure, since the two recessed portions 30 are located in symmetrical positions, deviation of the center of gravity of the coil component 10 in the direction parallel to the secondary axis Y due to the presence of the recessed portions 30 is less likely to occur. Accordingly, in the structure described above, the coil component 10 can be suppressed from falling when mounted on the substrate.
(9) In the embodiment, the shape of the opening edge 31 of the recessed portion 30 is a rectangle having a longitudinal direction parallel to the first axis X. For example, when light is emitted in the second positive direction Y1 and in the second negative direction Y2, an image of the two inclined planes 33 located in the second negative direction Y2 and in the second positive direction Y1 can be taken as regions with stronger reflected light than the second main surface M2. In addition, an image of these regions with strong reflected light is taken as regions with a longitudinal direction parallel to the first axis X while reflecting the shape of the two inclined planes 33 described above. Accordingly, the orientation of the coil component 10 can be determined by checking the direction of the regions with strong reflected light in the taken image.

### Modifications

The embodiment described above and the following modifications can be implemented by being combined with each other as long as no technical contradiction arises.

The shape of the winding core portion 11 is not limited to the example in the embodiment described above. For example, the shape of the winding core portion 11 may be an elliptic cylinder shape or a polygonal prism shape other than a quadrangular prism shape.

The coil component 10 may include two or more wires 50. It should be noted that, when the number of the wires 50 is two, the coil component 10 preferably further includes a third outer electrode attached to a portion closer to the first flange portion 21 and a fourth outer electrode attached to a portion closer to the second flange portion 22. In addition, the second wire 50 is preferably connected to the third outer electrode and the fourth outer electrode.

The shape of the wire 50 is not limited to the example in the embodiment described above. In cross-sectional view orthogonal to a direction in which the wire 50 extends, the shape of the wire 50 may be an ellipse or a polygon instead of a circle.

The material of the first outer electrode 41 and the second outer electrode 42 is not limited to the example in the embodiment described above.

The layer structure of the first outer electrode 41 and the second outer electrode 42 is not limited to the example in the embodiment described above. For example, the first outer electrode 41 and the second outer electrode 42 need only have at least one conductive layer. In addition, in the embodiment described above, the first outer electrode 41 and the second outer electrode 42 may also be plate-shaped metal terminals.

The material of the drum core 10C and the plate core 10F is not limited to the example in the embodiment described above. For example, the material of the drum core 10C and the plate core 10F is not limited to Ni—Zn ferrite and may also be Mn—Zn ferrite. In addition, the material of the drum core 10C and the plate core 10F is not limited to a magnetic material and may be alumina, a synthetic resin, or a mixture thereof.

The shape of the plate core 10F is not limited to a rectangular plate shape. That is, the shape of the first main surface M1 and the second main surface M2 is not limited to a rectangle.

The inclined planes 33 of the plate core 10F are not limited to the side surfaces of the recessed portion 30. For example, the inclined planes may extend in a direction projecting in the third negative direction Z2 from the second main surface M2. For example, as illustrated in the example in FIG. 6, the plate core 10F includes two raised portions 300 that project from the second main surface M2. The raised portions 300 are projections having a truncated quadrangular pyramid shape. The edge 310 of each of the raised portions 300 is rectangular as viewed in the direction orthogonal to the second main surface M2. In the embodiment, the edge 310 of each raised portion 300 has a rectangular shape with a longitudinal direction parallel to the first axis X. That is, two long sides of the edge 310 of each of the raised portions 300 are parallel to the first axis X. Two short sides of the edge 310 of each of the raised portions 300 are parallel to the second axis Y.

As illustrated in the example in FIG. 6, each of the raised portions 300 includes an end surface 320 and four inclined planes 330. That is, the plate core 10F has the inclined planes 330. The shape of the end surfaces 320 is a rectangle having a longitudinal direction parallel to the first axis X as viewed in the direction orthogonal to the second main surface M2.

As illustrated in the example in FIG. 6, the inclined planes 330 extend from the second main surface M2 to the end surface 320 of the respective raised portion 300. That is, the inclined planes 330 extend to the tip of each of the raised portions 300 from the four sides of the edge 310 of each of the rectangular raised portions 300. Accordingly, the plate core 10F has four inclined planes 330 for each of the raised portions 300. In addition, the edges of the inclined planes 330 closer to the tip of each of the raised portions 300 are connected to the sides of the outer edge of the end surface 320. It should be noted that the number of raised portions 300 may be one in the example illustrated in FIG. 6. In addition, the raised portion 300 may have a polygonal pyramid shape that does not have the end surface 320.

The angle W inside the recessed portion 30 formed by the virtual plane VP and the inclined plane 33 may be smaller than 10 degrees or may be greater than 80 degrees. The angle W described above need only be changed as appropriate in accordance with, for example, the position of the light source LS used to take an image of the coil component 10.

Not all sides of the recessed portion 30 may be the inclined planes 33. At least one of the side surfaces of the recessed portion 30 need only be the inclined plane 33. For example, some of the four side surfaces of the recessed portion 30 may be orthogonal to the second main surface M2. In addition, for example, the side surfaces of the recessed portion 30 may include a pair of inclined planes 33 and a pair of curved surfaces connecting the inclined planes 33 to each other. As a result, the shape of the opening edge 31 of the recessed portion 30 need not be a rectangle as viewed in the direction orthogonal to the second main surface M2.

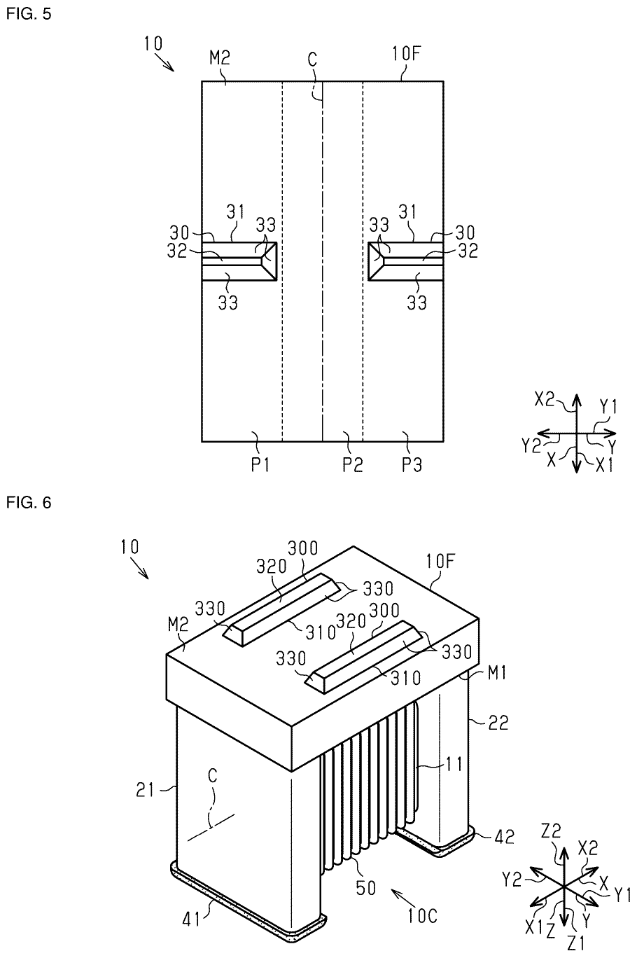

The recessed portion 30 may be open to the outside of the plate core 10F in the direction parallel to the first axis X and in the direction parallel to the secondary axis Y. For example, in the example illustrated in FIG. 5, in the recessed portions 30, the opening edge 31 of each of the recessed portion 30 extends to an edge of the second main surface M2. In other words, one side of the recessed portion 30 in a direction parallel to the secondary axis Y is open to the outside of the plate core 10F. As a result, the recessed portion 30 has three inclined planes 33. Also in the example illustrated in FIG. 5, the effect described in (1) can also be obtained.

The shape of the recessed portion 30 is not limited to a truncated quadrangular pyramid shape. For example, the recessed portion 30 may have a polygonal pyramid shape other than a quadrangular pyramid shape. In addition, the shape of the recessed portion 30 may be a polygonal pyramid shape, such as a truncated quadrangular pyramid shape. That is, the recessed portion 30 need not have the bottom surface 32.

The plate core 10F need only have at least one recessed portion 30. Even when there is only one recessed portion 30 in the plate core 10F, the recessed portion 30 is preferably located so as not to be aligned with the central axis line C of the winding core portion 11 as viewed in the direction orthogonal to the second main surface M2.

The plate core 10F may have three or more recessed portions 30. When the plate core 10F has three or more recessed portions 30, the positional relationship between two of the three recessed portions 30 is preferably line-symmetric about the central axis line C of the winding core portion 11 as viewed in the direction orthogonal to the second main surface M2. In addition, when the plate core 10F has a plurality of recessed portions 30, the side surfaces of each of the plurality of recessed portions 30 are preferably inclined planes 33. In addition, when the plurality of recessed portions 30 are present, the shapes of the recessed portions 30 may differ from each other or only some of the recessed portions 30 may have the same shape.

The recessed portion 30 may be located in the second region P2 in the middle of the three regions on the second main surface M2 of the plate core 10F. In addition, the recessed portion 30 may be located on the central axis line C of the winding core portion 11 as viewed in the direction orthogonal to the second main surface M2.

The positional relationship between the recessed portions 30 on the second main surface M2 can be changed as appropriate. The orientation of the coil component 10 can be determined in accordance with the positions of the recessed portions 30 by setting the positions of the recessed portions 30 to positions that are not rotationally symmetrical with respect to the center point of the second main surface M2.

### Addition

The technical concept derived from the embodiment and the modifications described above will described below.
[1] A coil component comprising: a first core including a columnar winding core portion, a first flange portion connected to a first end of the winding core portion in a direction parallel to a central axis line of the winding core portion, and a second flange portion connected to a second end of the winding core portion opposite to the first end; a plate-shaped second core having a first main surface; and a wire wound around the winding core portion. The first main surface is connected to the first flange portion and the second flange portion, and the second core has, on a side opposite to the first main surface, a second main surface parallel to the first main surface and an inclined plane inclined with respect to the second main surface.
[2] The coil component according to [1], wherein the second core has a recessed portion in the second main surface, and the inclined plane is a side surface of the recessed portion that extends toward a bottom of the recessed portion from the second main surface.
[3] The coil component according to [2], wherein an opening edge of the recessed portion is rectangular as viewed in a direction orthogonal to the second main surface, and the inclined plane extends from each of four sides of the rectangular opening edge.
[4] The coil component according to [2] or [3], wherein an angle inside the recessed portion is not less than 10 degrees and not more than 80 degrees (i.e., from 10 degrees to 80 degrees), the angle being formed by the inclined plane and a virtual plane including the second main surface.
[5] The coil component according to any one of [2] to [4], wherein the second core is made of a magnetic material, and the recessed portion is not located on the central axis line of the winding core portion as viewed in a direction orthogonal to the second main surface.
[6] The coil component according to [5], wherein, when the second main surface is divided into three equal regions in a direction parallel to the second main surface and orthogonal to the central axis line of the winding core portion, the recessed portion is located in one of the two regions excluding a central region of the three regions.
[7] The coil component according to any one of [2] to [6], wherein the second core has a plurality of recessed portions, the recessed portion being one of the plurality of recessed portions, and the side surface of each of the recessed portions is the inclined plane.
[8] The coil component according to claim 7, wherein in a direction orthogonal to the second main surface, a positional relationship between two of the plurality of recessed portions is line-symmetric about the central axis line of the central axis line of the winding core portion.
[9] The coil component according to claim 1, wherein the second core has a raised portion that projects from the second main surface, and the inclined plane is a side surface of the raised portion, the side surface extending from the second main surface toward a tip of the raised portion.

What is claimed is:

1. A coil component comprising:
a first core including a columnar winding core portion, a first flange portion connected to a first end of the winding core portion in a direction parallel to a central axis line of the winding core portion, and a second flange portion connected to a second end of the winding core portion opposite to the first end;
a plate-shaped second core having a first main surface; and
a wire wound around the winding core portion,
wherein
the first main surface is connected to the first flange portion and the second flange portion, and
the second core has, on a side opposite to the first main surface, a second main surface parallel to the first main surface and an inclined plane inclined with respect to the second main surface.

2. The coil component according to claim 1, wherein
the second core has a recessed portion in the second main surface, and
the inclined plane is a side surface of the recessed portion that extends toward a bottom of the recessed portion from the second main surface.

3. The coil component according to claim 2, wherein
an opening edge of the recessed portion is rectangular as viewed in a direction orthogonal to the second main surface, and
the inclined plane extends from each of four sides of the rectangular opening edge.

4. The coil component according to claim 2, wherein
an angle inside the recessed portion is from 10 degrees to 80 degrees, the angle being defined by the inclined plane and a virtual plane including the second main surface.

5. The coil component according to claim 2, wherein
the second core includes a magnetic material, and
the recessed portion is not on the central axis line of the winding core portion as viewed in a direction orthogonal to the second main surface.

6. The coil component according to claim 5, wherein
when the second main surface is divided into three equal regions in a direction parallel to the second main surface and orthogonal to the central axis line of the winding core portion, the recessed portion is in one of the two regions excluding a central region of the three regions.

7. The coil component according to claim 2, wherein
the second core has a plurality of recessed portions, the recessed portion being one of the plurality of recessed portions, and
the side surface of each of the recessed portions is the inclined plane.

8. The coil component according to claim 7, wherein
as viewed in a direction orthogonal to the second main surface, a positional relationship between two of the plurality of recessed portions is line-symmetric about the central axis line of the central axis line of the winding core portion.

9. The coil component according to claim 1, wherein
the second core has a raised portion that projects from the second main surface, and
the inclined plane is a side surface of the raised portion, the side surface extending from the second main surface to a tip of the raised portion.
